(19) United States
(12) Patent Application Publication
(10) Pub. No.: US 2004/0064835 A1
(43) Pub. Date: Apr. 1, 2004

(54) System and method for content based on-demand video media overlay

(75) Inventors: Thomas Alexander Bellwood, Austin, TX (US); Julio Eloy Ruano, Austin, TX (US); Matthew Francis Rutkowski, Pflugerville, TX (US); Merle Douglas Sterling, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/255,352

(22) Filed: Sep. 26, 2002

(51) Int. Cl. H04N 7/173; H04N 5/445

(52) U.S. Cl. 725/87; 725/40; 725/46; 725/92; 725/98; 725/99

(57) ABSTRACT

A system and method for content based on-demand video media overlay is presented. A user uses a media manager, such as a set-top box, to register for an event. The media manager retrieves information from an event data packet, which includes a detection identifier, to register the event. After registration, the media manager matches event identifiers provided by a content provider with the registered event's detection identifier. When the media manager determines a match, the media manager retrieves an identified event corresponding to the matched event identifier, formats the identified event using user-defined preferences, and displays the formatted identified event on a media device, such as a television. The user may also configure the media manager to store formatted identified events in a nonvolatile storage area for later viewing.

### BACKGROUND OF THE INVENTION

1. Technical Field

The present invention relates in general to a system and method for providing content based on-demand video media. More particularly, the present invention relates to a system and method for formatting an identified event based upon user preferences and overlaying the event on a media display device.

2. Description of the Related Art

Many households today have a home receiver system that provides a vast amount of content to a consumer. For example, a consumer may subscribe to a content provider, such as a cable TV company or a satellite network company, in which the content provider offers the consumer over 100 channels to view. Consumers, however, face a burden of selecting which channel to view at a particular time from the vast number of channels. A consumer may become frustrated at the amount of selection and fail to identify a television program.

Content providers offer “packages” in order to generate more company revenue. These packages, such as a “sports package” or a “movie package”, add more channels to a consumer's viewing capacity for a monthly price. A challenge found with the content provider's business model is that the “packages” increase consumers' frustrations due to the increase of available channels.

Content providers may attempt to reduce the consumer's frustration by providing a channel listing and basic programming capability using a media manager, such as a set-top box. For example, a content provider's set-top box may allow a consumer to select an upcoming television program and the set-top box switches to the television program's corresponding channel when the television program starts. Even with basic programming capability, a consumer may frequently “channel surf” in order to view particular events on different channels. The consumer may not be interested in viewing a television program in its entirety, but rather view portions of the television program. For example, a consumer may wish to watch a movie, view his favorite baseball player at bat, and view local weather conditions when a storm approaches. One challenge is that the consumer switches between many television channels, but misses his particular event of interest.

Existing art allows a consumer to view two television channels simultaneously. Content from a first television channel is displayed on an entire television screen while content from a second channel is displayed in a small pop-up window, often called “picture-in-picture” technology. A challenge found with viewing two television channels simultaneously is that it reduces a consumer's ability to focus on any one event.

What is needed, therefore, is a way for a consumer to view particular event content without viewing an entire television program and displaying the event in a format suitable to the consumer.

### SUMMARY

It has been discovered that the aforementioned challenges are resolved by programming a media manager to detect, format, and display an identified event based upon a user's preference settings. The user registers an event that includes a detection identifier with the media manager. After registration, the media manager matches event identifiers provided by a content provider with the registered event's detection identifier. When the media manager detects a match, the media manager retrieves a corresponding event, formats the event, and displays the formatted event in a user-defined pop-up window on a media device. The user may simultaneously display multiple formatted identified events in different user-defined pop-up windows.

A content producer produces content (i.e. a baseball game) and event data packets corresponding to events occurring within the content (i.e. “Player X at Bat”). A particular television program may have multiple event data packets corresponding to various events throughout the television program. For example, a baseball game may have event data packets corresponding to events such as “Bonds at Bat”, “Sosa at Bat”, “Cubs scoring”, and “Giants scoring”. The content producer provides event data packets to a content provider. For example, the content producer may be a television network and the content provider may be a cable company.

The content provider may wish to include event data packets corresponding to events other than what the content producer provides. Using the example described above, a television network may only provide event data packets corresponding to when a baseball team scores and the content provider may wish to add event data packets corresponding to when a particular player is at bat. The content provider includes event data packets corresponding to non-producer supported events, and sends producer/provider event data packets to a user's media manager. In addition, third parties, such as fan clubs, may provide more event identifiers that can be received by users over a computer network, such as the Internet.

The media manager receives the producer/provider event data packets and provides the user a menu to select a particular event. Once the user selects an event, the media manager registers the event using information included in the corresponding producer/provider event data packet and display mode information included in a nonvolatile storage area. Once an event is registered, the media manager is ready to match a registered event's detection identifier with event identifiers sent from the content provider.

During a television program broadcast, the content provider sends event identifiers corresponding to particular events that occur during a television broadcast, such as when a baseball team scores. The event identifiers may originate from the content producer or they may originate from the content provider. The user's media manager receives the event identifiers and matches each event identifier with one or more registered identifiers included in registered event information. When the media manager detects a match, the media manager selects an identified event corresponding to the matched event identifier and formats the identified event based upon stored preference information. The media manager determines whether the user wishes to view the formatted identified event immediately or store the formatted identified event for later viewing. If the user wishes to view the identified event immediately, the media manager overlays or merges the formatted identified event with existing content, resulting in a composite media. For example, the existing content may be a movie that the user is currently viewing, and the formatted identified event may be a baseball player at bat. The media manager provides the composite media to a display device for viewing, such as a television. Once the identified event finishes, the media manager removes the formatted identified event and the display device continues playing existing content according to defined display and audio preferences.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high level diagram showing a user registering for one or more future events;

FIG. 2 is a high level diagram showing a media manager receiving content and event identifiers corresponding to the content and displaying selected events on a media device;

FIG. 3 is a flowchart showing steps taken in receiving a user request and processing the request;

FIG. 4 is a flowchart and corresponding menus showing steps taken in selecting a future event for viewing;

FIG. 5 is a flowchart showing steps taken in registering an event;

FIG. 6 is a flowchart showing steps taken in configuring a display mode;

FIG. 7A is a user interface window showing registered events and corresponding event preferences;

FIG. 7B is a user interface window showing display modes and corresponding preferences;

FIG. 8 is a flowchart showing steps taken in receiving an event identifier and providing an identified event to a user;

FIG. 9 is a diagram of one embodiment of the invention utilizing multiple tuners to detect desired event identifiers; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

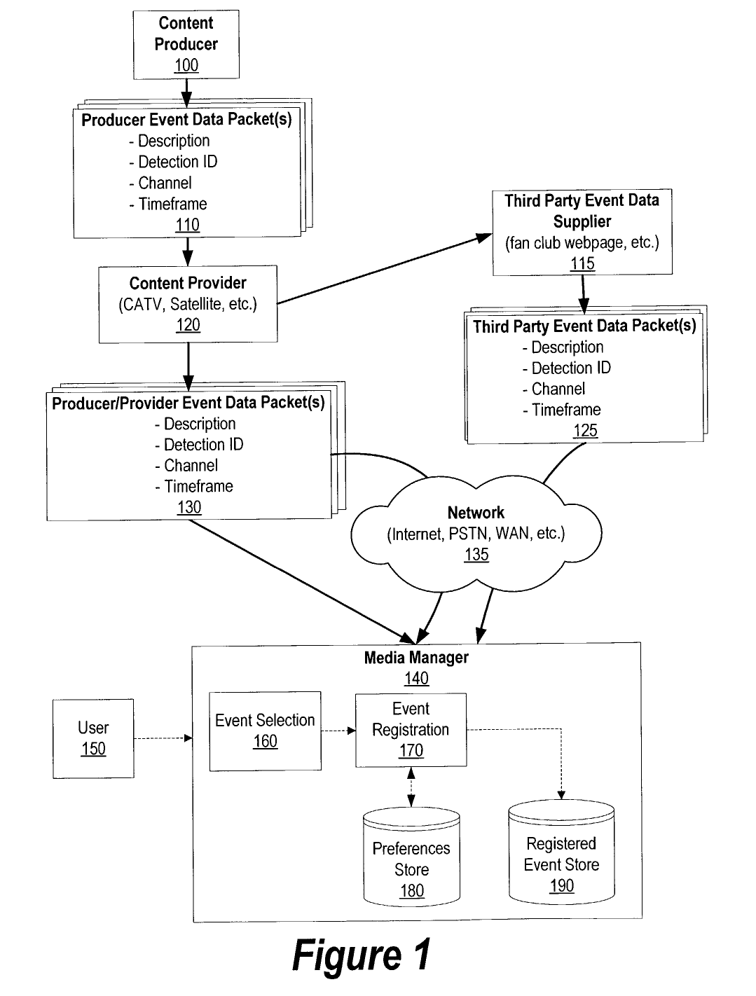

FIG. 1 is a diagram showing a user registering a future event to view using media manager 140. Content producer 100 produces content, such as baseball games, and event data packets corresponding to the content. Event data packets correspond to events that do not occur at a particular time (i.e. “Player X at Bat”). A particular television program may have multiple event data packets corresponding to various events throughout the television program. For example, a baseball game may have event data packets corresponding to events such as “Bonds at Bat”, “Sosa at Bat”, “Cubs scoring”, and “Giants scoring”. Content producer 100 provides producer event data packet(s) 110 to content provider 120. For example, content producer 100 may be a television network and content provider 120 may be a cable company.

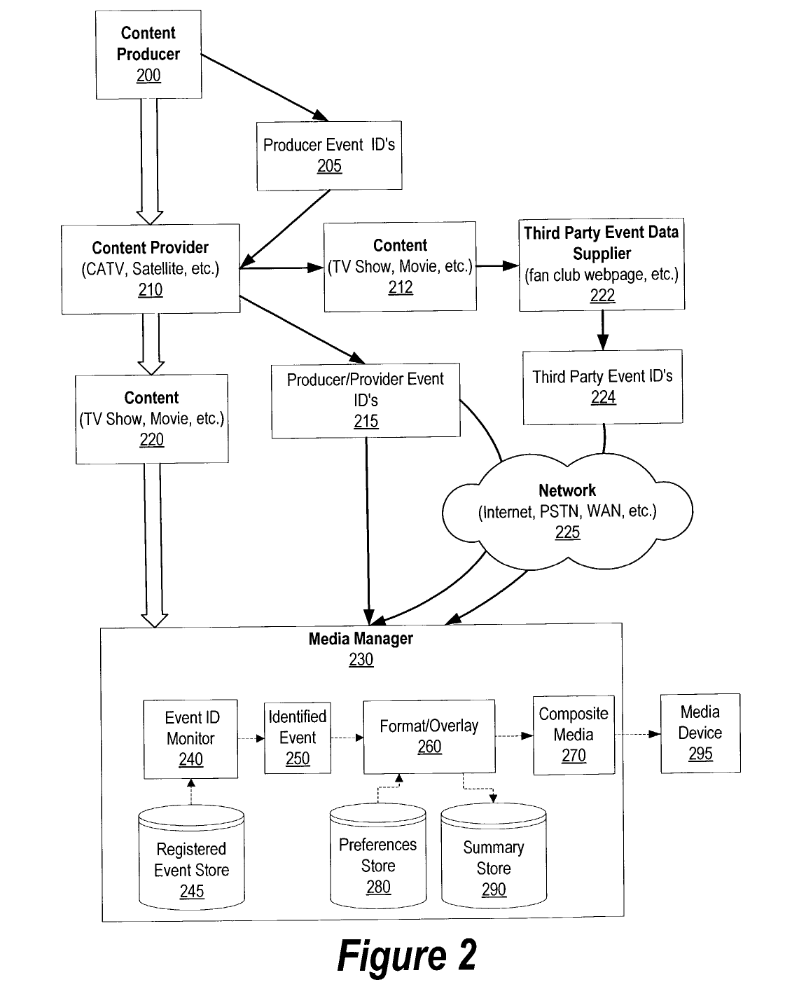

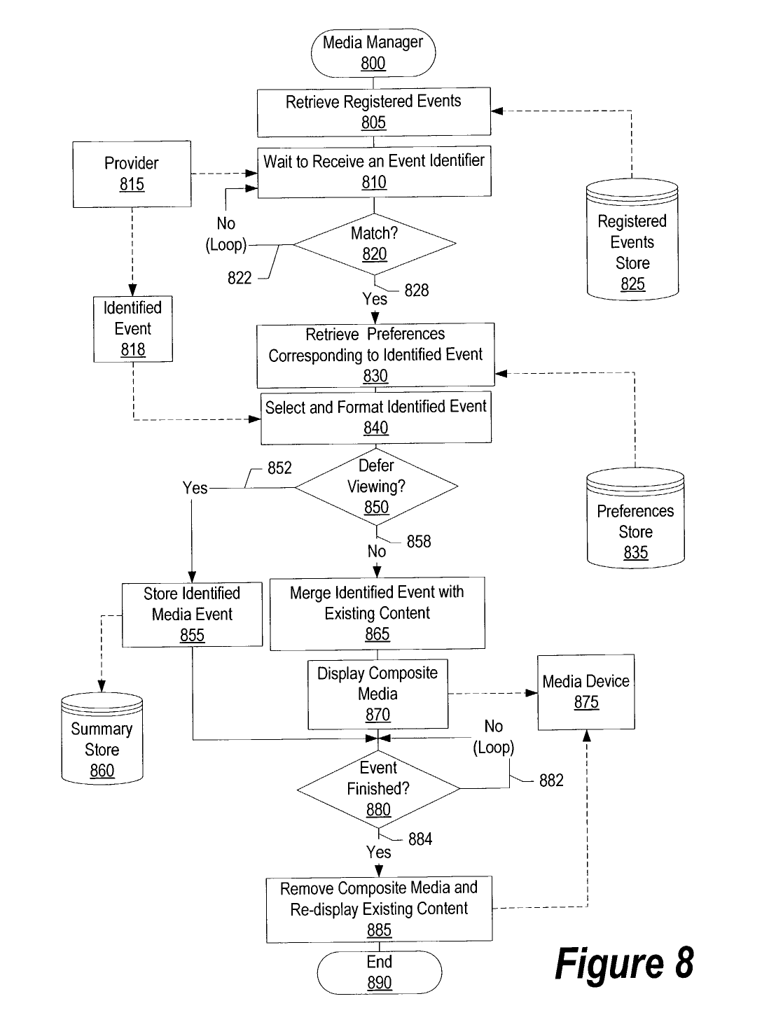

Producer event data packet(s) 110 include an event description, a detection identifier, a channel location, and a timeframe. The event description describes a future event, such as “Sosa at Bat”. The detection identifier is a unique value that media manager 140 uses to detect future event identifiers, such as “1234” (see FIGS. 2, 8, and corresponding text for further details regarding event identifier detection). The channel location corresponds to the channel on which the media event is broadcasted, such as “Channel 53”. The timeframe corresponds to a time duration that media manager 140 matches event identifiers with the detection identifier and ascertains whether a registered event is occurring (see FIGS. 2, 8, and corresponding text for further details regarding event detection). The timeframe is not a specific time but rather a range during which an event of interest may occur.

Content provider 120 may wish to include event data packets corresponding to events other than what content producer 100 provides. Using the example described above, a television network may only provide event data packets corresponding to when a baseball team scores and content provider 120 may wish to add event data packets that detect when a particular player is at bat. In this example, content provider 120 also provides event identifiers corresponding to the new event data packets when the event occurs. Content provider 120 includes event data packets corresponding to non-producer supported events, and sends producer/provider event data packet(s) 130 to media manager 140. Producer/provider event data packet(s) 130 includes producer supported event data packets as well as provider supported event data packets. Producer/provider event data packet(s) 130 may be sent directly to media manager 140 using content provider 120's network, such as a cable network, or producer/provider event data packet(s) 130 may be sent to media manager 140 through network 135, such as the Internet.

In one embodiment, third party event data supplier 115 may provide event data packet(s) 125 to media manager 140 through computer network 135. For example, third party event data supplier 115 may be a website, such as a baseball fan club website, and provide event data packets for registration that include a detection identifier to detect when a particular baseball player is at bat (i.e. “Sosa at Bat”). In turn, third party event data supplier 115 may have an employee watching baseball games and send corresponding event identifiers through a computer network, such as when the particular player is at bat, for the user's media manager to match (see FIG. 2 and corresponding text for further details regarding event identifier matching).

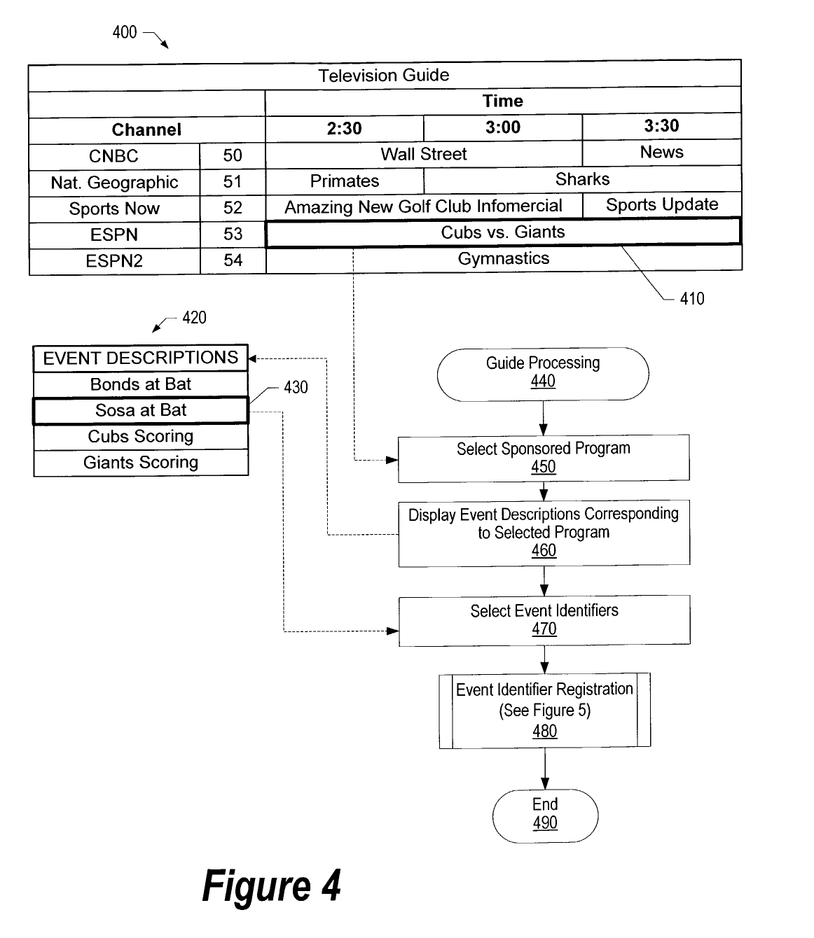

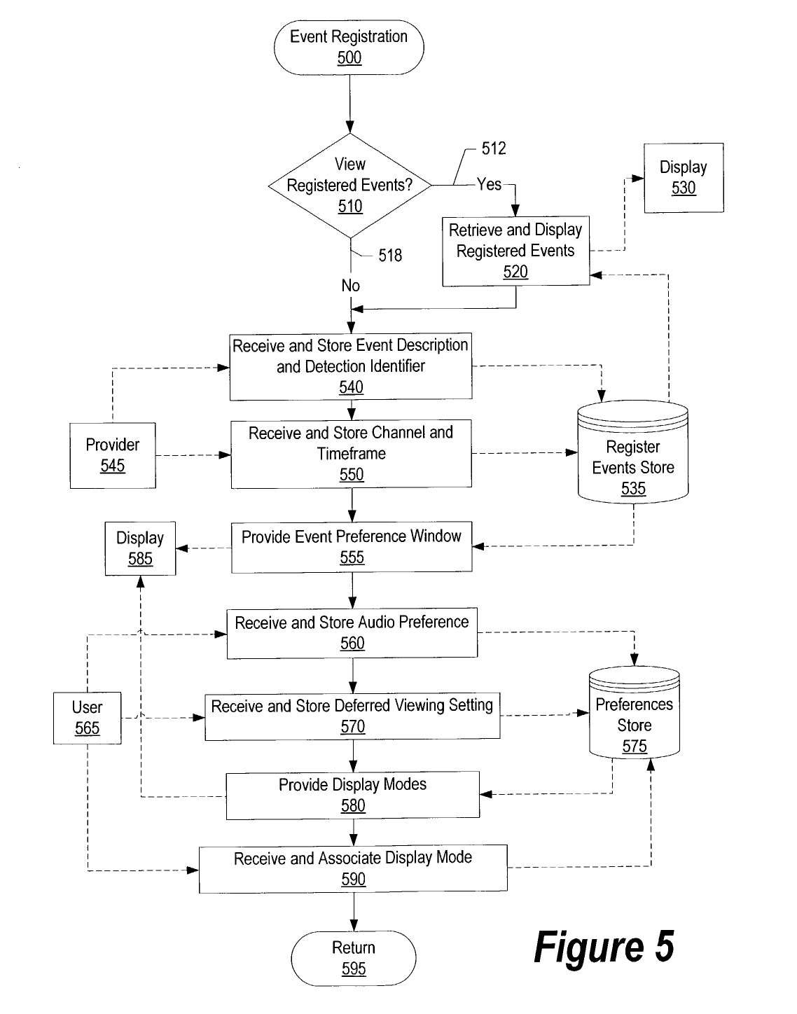

Media manager 140 receives producer/provider event data packet(s) 130. Event selection 160 provides user 150 with menus for user 150 to select a particular event (see FIG. 4 and corresponding text for further details regarding event selection). Once user 150 selects an event, event registration 170 registers the event. Event registration 170 retrieves event data corresponding to the selected event from producer/provider event data packet(s) 130, preference information from preferences data store 180, and stores the event data and preference information as a registered event in registered event data store 190 (see FIG. 5 and corresponding text for further details regarding event registration). Once an event is registered, media manager 140 is ready to match the registered event's detection identifier with event identifiers sent from content provider 120 (see FIG. 2 and corresponding text for further details regarding event detection).

In one embodiment, media manager 140 may send selected detection identifiers to content provider 120 and, upon matching, content provider 120 may send only matched event identifiers as they occur to media manager 140.

FIG. 2 is a diagram showing a media manager receiving content, such as a television program, and event identifiers corresponding to media events which occur within the content. A media event may include an event in a television program (i.e. “Sosa at Bat”), a commercial, a web cast, or a public announcement (i.e. “thunderstorm warning”). Content producer 200 produces content, such as a baseball game, and event identifiers corresponding to events. Event identifiers correspond to events that do not occur at a pre-determined time and may be in the format of a unique value, such as “1234”. Event identifiers are provided to media manager 230 each time a corresponding event occurs during a television program. For example, an event identifier may correspond to when a baseball teams scores. In this example, a content producer or content provider provides an event identifier to media manager 230 each time the baseball team scores. Content producer 200 provides producer event identifiers 205 to content provider 210. For example, content producer 200 may be a television network, content provider 210 may be a cable company, and producer event identifier 205 may have a value of “1234” which indicates that a baseball team scores in the baseball game.

Content provider 210 may wish to include event identifiers corresponding to events other than what content producer 200 provides. Using the example described above, a television network may only provide event identifiers corresponding to when a baseball team scores and content provider 210 may wish to add event identifiers that identify when a particular player is at bat. Content provider 210 includes event identifiers corresponding to non-producer supported events, and sends producer/provider event identifiers 215 to media manager 230. Producer/provider event identifiers 215 includes producer supported event identifiers as well as provider supported event identifiers. Producer/provider event identifiers 215 may be sent directly to media manager 230 using content provider 210's network, such as a cable network, or producer/provider event identifiers 215 may be sent to media manager 230 through computer network 225, such as the Internet.

In one embodiment, content provider 210 sends content 212 to third party event data supplier 222 and third party event data supplier 222 sends corresponding third party event id's 224 to media manager 230 through computer network 225. For example, third party event data supplier 222 may be a website, such as a baseball fan club website, and provides event id's, such as third party event id's 224, corresponding to when a particular baseball player is at bat (i.e. “Sosa at Bat”).

Event identifier monitor 240 retrieves registered event data from registered event data store 245. Each registered event includes a unique detection identifier that event identifier monitor 240 matches with event identifiers included in producer/provider event identifier(s) 215. When event identifier monitor 240 detects a match, event identifier monitor 240 selects identified event 250 which is included in content 220 and corresponds to the matched event identifier (see FIG. 8 and corresponding text for further details regarding event detection).

Format/overlay process 260 retrieves preference information from preferences data store 280 which includes display mode preferences, a deferred viewing preference, and an audio preference. Format/overlay process 260 formats identified event 250 using the display mode and audio preference information. Format/overlay process 260 reviews the deferred viewing preference and determines whether the formatted identified event should be displayed on media device 295 or stored in summary data store 290 for later viewing. If the deferred viewing preference is “Yes”, format/overlay process 260 stores the formatted identified event in summary data store 290. Summary data store 290 may be stored on a nonvolatile storage area, such as a computer hard drive.

On the other hand, if the deferred viewing preference is “No”, format/overlay process 260 overlays the formatted identified event on existing content currently displayed on media device 295, creating composite media 270. As those skilled in the art can appreciate, format/overlay process 260 may use standard audio/video overlay and mixing techniques to overlay the formatted event with existing content. Using the example described above, media device 295 may be displaying a movie (e.g. existing content) and composite media 270 may include the movie with a pop-up window showing a baseball player at bat. Media manager 230 provides composite media 270 to media device 295 using video standards (i.e. RGB), television standards (i.e. NTSC and PAL), or using a computer network, such as the Internet. Once the identified event is finished, media manager 230 removes the formatted identified event and media device 295 continues playing existing content according to defined display and audio preferences (see FIG. 8 and corresponding text for further details regarding composite media).

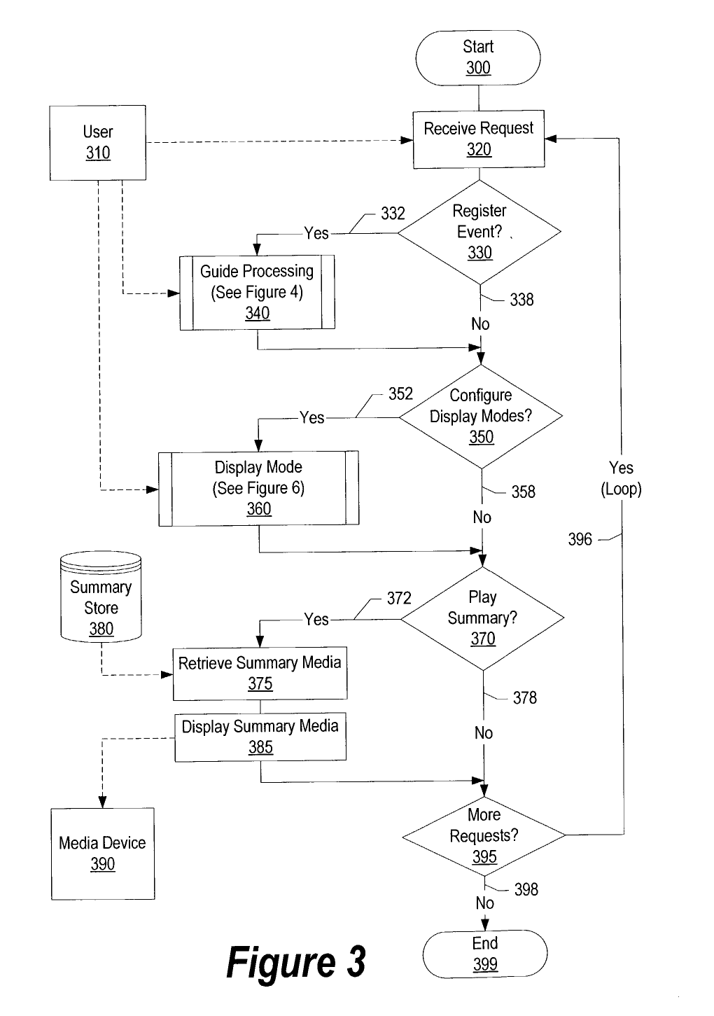

FIG. 3 is a flowchart showing steps taken in receiving a user request and processing the request. Processing commences at 300, whereupon processing receives a request from user 310 at step 320. A determination is made as to whether user 310 wishes to register an event (decision 330). The event is an event that does not occur at a pre-determined time, such as at “2:00 pm”. For example, user 310 may not wish to view a baseball game in its entirety, but wishes to view the baseball game each time a particular baseball player is at bat. If user 310 wishes to register an event, decision 330 branches to “Yes” branch 332 whereupon processing retrieves information pertaining to the event (pre-defined process block 340, see FIG. 4 and corresponding text for further details). On the other hand, if the user's request is not to register an event, decision 330 branches to “No” branch 338, bypassing event registration steps.

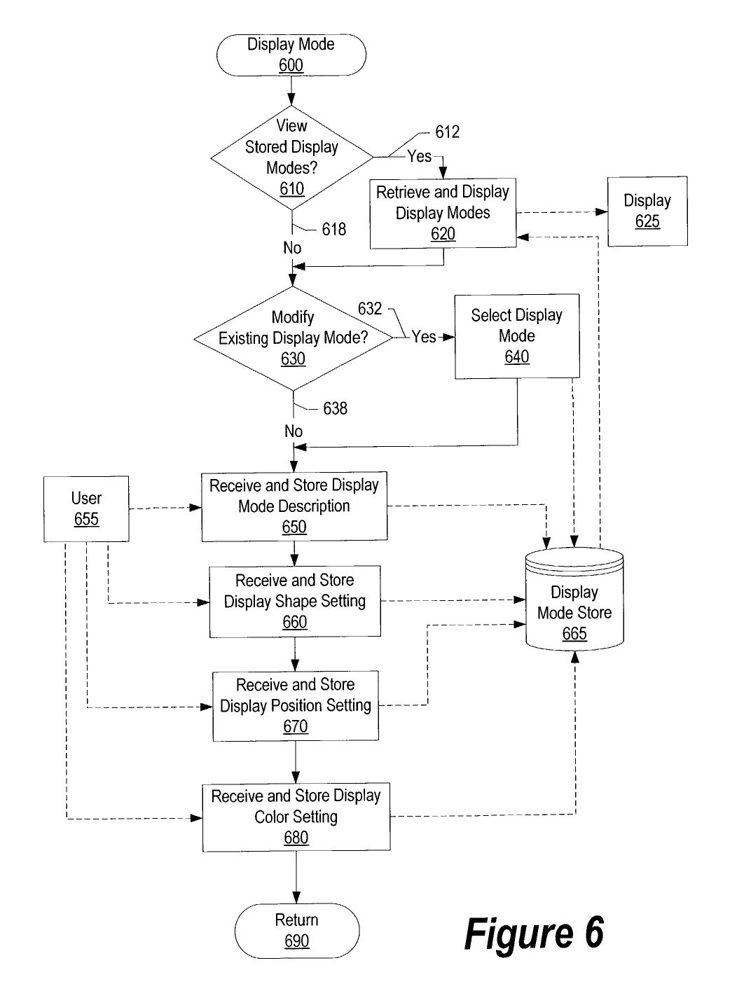

A determination is made as to whether user 310 wishes to configure a display mode (decision 350). Display modes are used to format an identified event for viewing. An identified event is an event in which its corresponding event identifier matches a registered event's detection identifier. Using the example described above, user 310 may configure a display mode to display the baseball player at bat in a square pop-up window on the lower left side of his display. If user 310 wishes to configure a display mode, decision 350 branches to “Yes” branch 352 whereupon processing configures a display mode (pre-defined process block 360, see FIG. 6 and corresponding text for further details). On the other hand, if user 310 does not wish to configure a display mode, decision 350 branches to “No” branch 358, bypassing display mode configuration steps.

A determination is made as to whether user 310's request is to play a summary of previously stored identified events (decision 370). For example, user 310 may have configured the media manager to store one or more identified event in a nonvolatile storage area instead of displaying the identified event on his media device. If user 310 wishes to play a summary of identified events, decision 370 branches to “Yes” branch 372 whereupon stored events are retrieved from summary data store 380 at step 375. Summary data store 380 may be stored on a nonvolatile storage area, such as a computer hard drive. Processing provides the stored identified events to media device 390, such as a television or monitor, at step 385.

On the other hand, if user 310 does not wish to play a summary of identified events, decision 370 branches to “No” branch 378, bypassing summary retrieval and displaying steps. A determination is made as to whether user 310 has more requests (decision 395). If user 310 has more requests, decision 395 branches to “Yes” branch 396 which loops back to process additional requests. This looping continues until user 310 has no more requests to process, at which point decision 395 branches to “No” branch 398 and processing ends at 399.

FIG. 4 is a flowchart and corresponding menus showing steps taken in selecting a future event for viewing. Guide 400 shows content information received from a content provider, such as a cable TV provider. Guide 400 includes channel information, time information, and a title (i.e. description) of each television program. Guide processing commences at 440, whereupon the user selects a particular television program using guide 400 (step 450). In the example shown in FIG. 4, the user selects program 410 which is a baseball game.

Processing retrieves event data packet information from the content provider corresponding to the selected program. Event data packet information may include an event description (i.e. “Sosa at bat”), a detection identifier (i.e. 1234), a channel locator (i.e. “53”), and a timeframe (i.e. 2:30 pm-5:00 pm). Once processing retrieves event data packet information from the content provider, processing displays menu 420 which includes a list of event descriptions corresponding to the chosen television program (step 460). The user selects an event at step 470. In the example shown in FIG. 4, the user selects event description 430 (“Sosa at Bat”).

In one embodiment, processing may display a list of event descriptions that are not dependent upon a channel or timeframe. For example, a third party provider may provide event data packets that correspond to a particular player at bat, regardless of when the baseball player's team plays or which channel shows the baseball game. In this example, the event data packet may include an event description and a detection identifier without a corresponding channel number or timeframe.

Processing analyzes information pertaining to the selected event description, and registers the event for viewing (pre-defined process block 480, see FIG. 5 and corresponding text for further details). Guide processing ends at 490.

FIG. 5 is a flowchart showing steps taken in registering an event. Event registration processing commences at 500, whereupon a determination is made as to whether a user wishes to view existing registered events (decision 510). For example, the user may be in the process of registering a new event and wish to view existing registered events that may occur during the same timeframe as the new event. If the user wishes to view existing registered events, decision 510 branches to “Yes” branch 512 whereupon processing retrieves registered events from registered events data store 535 and displays the registered events on display 530 (step 520). Register events data store 535 may be stored on a nonvolatile storage area, such as nonvolatile memory.

On the other hand, if the user does not wish to view existing registered events, decision 510 branches to “No” branch 518, bypassing registered event viewing steps. Processing receives an event description and a detection identifier from provider 545 and stores them in registered events data store 535 (step 540). The event description is a description of a corresponding event and the detection identifier is a unique value that processing matches with incoming event identifiers to detect when a corresponding event occurs. For example, an event description may be “Sosa at Bat” and a corresponding detection identifier may be “1234” (see FIG. 8 and corresponding text for further details regarding event identifier detection).

Processing receives channel location and timeframe information corresponding to the registered event from provider 545 and stores the channel location and timeframe information in registered events data store 535 (step 550). Using the example describe above, processing retrieves the channel number (i.e. “channel 53”) and timeframe (i.e. 2:30 pm-5:00 pm) corresponding to where the baseball game will be broadcast. In one embodiment, a user registers for event (i.e. “Sosa at Bat”) to occur on any channel at any time. In this embodiment, event id's corresponding to the registered event include the channel number as to where the event is occurring (see FIGS. 2, 8, and corresponding text for further details regarding receiving event id's).

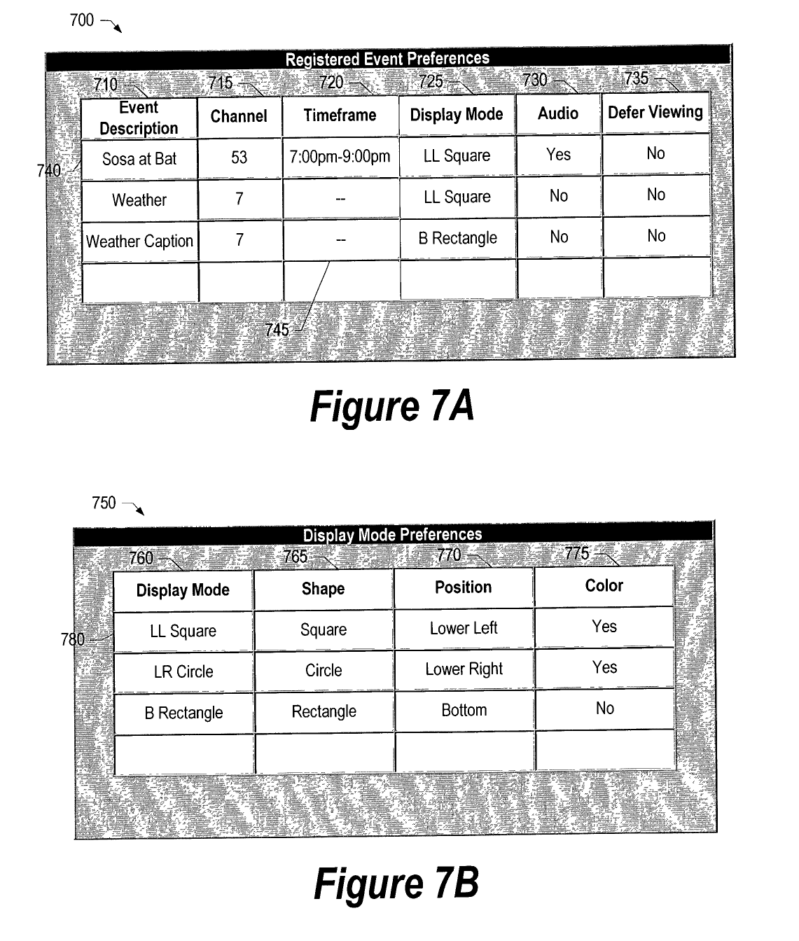

Processing displays a registered event preferences window on display 585 which includes registered event information retrieved from register events data store 535 (step 555) (see FIG. 7A and corresponding text for further details regarding the registered event preference window). In one embodiment, user 565 may modify timeframe information corresponding to a particular event. For example, user 565 may wish to be notified of local storm alerts throughout the day instead of just during a news hour.

Processing receives an audio preference from user 565 and stores the audio preference in preferences data store 575 (step 560). The audio preference identifies whether user 565 wishes to hear corresponding audio when processing identifies an event. For example, if the audio preference is “Yes”, then the event's audio plays when the event occurs and if the audio preference is “No”, the event's audio does not play when the event occurs. Processing receives user 565's deferred viewing preference and stores the deferred viewing preference in preferences data store 575 at step 570. The deferred viewing preference identifies whether the user wishes to view an identified event as it occurs or whether the user wishes to store the identified event in a nonvolatile storage area for later viewing.

Processing retrieves display modes from preferences data store 575 and displays a display mode preferences window on display 585 at step 580. The display mode preferences window includes display properties for a pop-up window that is used for displaying an identified event. Display mode preferences may include the shape of the window, the window positioning, and whether the window is color or black and white (see FIG. 7B and corresponding text for further details regarding display mode preferences).

Processing receives user 565's display mode preference and associates the display mode preference with the registering event in preferences data store 575 (step 590). Processing returns at 595.

FIG. 6 is a flowchart showing steps taken in configuring a display mode. A user is able to configure display modes and associate a display mode with a registered event. Display modes are used to customize the way at which an identified event is overlaid on a display (pop-up window). For example, the user may wish to be notified if a local weather condition arises while watching a movie on cable television. In this example, the user may wish to configure a “bottom rectangle” display mode for displaying text in a rectangle at the bottom of a display for text corresponding to a local weather condition.

Display mode processing commences at 600, whereupon a determination is made as to whether the user wishes to view existing display modes (decision 610). Using the example described above, the user may wish to scan existing display modes in order to determine if a “bottom rectangle” display mode is already stored. If the user wishes to view existing display modes, decision 610 branches to “Yes” branch 612 whereupon processing retrieves existing display modes from display mode data store 665 and displays the display modes on display 625. Display mode data store 665 may be stored on a nonvolatile storage area, such as nonvolatile memory. On the other hand, if the user does not wish to view existing display modes, decision 610 branches to “No” branch 618, bypassing stored display mode retrieving steps.

A determination is made as to whether the user wishes to modify an existing display mode (decision 630). Using the example described above, the user may identify an existing display mode named “center rectangle” where its preference positions the rectangle in the center of a display. If the user wishes to modify an existing display mode, decision 630 branches to “Yes” branch 632 whereupon processing selects the corresponding display mode in display mode data store 665. On the other hand, if the user does not wish to modify an existing display mode, decision 630 branches to “No” branch 638, bypassing display mode selection steps.

Processing receives and stores a display mode description from user 655 at step 650. The display mode description identifies the corresponding display mode. Using the example described above, processing receives “bottom rectangle” from user 655. Processing receives and stores a corresponding display shape setting from user 655 and stores the display shape setting in display mode data store 665 at step 660. The display shape setting corresponds to the shape of the overlaid window. In one embodiment, user 655 may be offered a selection of display shapes, such as “rectangle”, “square”, or “circle”. Using the example described above, processing receives “rectangle” from user 655.

Processing receives and stores a corresponding position setting from user 655, and stores the position setting in display mode data store 665. The position setting corresponds to the position of the overlaid window. In one embodiment, processing may section a display into a three by five grid and provide the user with an option to select one of fifteen blocks as the overlay position setting. Using the example described above, the user selects “bottom center” for the corresponding display mode position.

Processing receives and stores a corresponding color setting from user 655, and stores the color setting in display mode data store 665 at step 680. The color setting corresponds to whether the overlaid window will be in color or in black and white. Using the example described above, the user may select “black and white” for the displayed text in order to not distract the user extensively from viewing the movie. Processing returns at 690.

FIG. 7A is a user interface window showing registered events and corresponding event preferences. Processing displays window 700 when a user wishes to view existing registered events and when a user registers a new event (see FIG. 5 and corresponding text for further details regarding event registration). Window 700 includes column 710, column 715, column 720, column 725, column 730, and column 735. Column 710 includes a list of event descriptions corresponding to registered events. Row 740 shows a registered event that has an event description of “Sosa at Bat”. Column 715 includes a channel listing for each registered event. Row 740 shows that the “Sosa at Bat” registered event is on channel “53”. Column 720 includes timeframe information as to when each corresponding event may occur. Row 740 shows that the “Sosa at Bat” registered event occurs between 2:30 pm and 5:00 pm. A user may choose to have processing continuously monitor a channel's event identifiers without an associated timeframe, as shown in box 745. In one embodiment, processing may display a date associated with the registered event.

Column 730 and column 735 include information supplied by a user. Column 730 includes an audio preference for each registered event. If the audio preference is “Yes”, then the event's audio will be played when the event occurs. If the audio preference is “No”, then the event's audio will not be played when the event occurs. Row 740 shows the audio option for “Sosa at Bat” is “Yes”. Therefore, when a “Sosa at Bat” event occurs, a corresponding audio will be played. Column 735 includes a deferred viewing preference for each registered event. If the deferred viewing preference is “Yes”, then processing stores the identified event in a nonvolatile storage area for later viewing. If the deferred viewing preference is “No”, then processing displays the identified event on the user's display in a pop-up window. Row 740 shows that the “Sosa at Bat” identified event will be displayed on the display when processing detects its corresponding event identifier.

FIG. 7B is a user interface window showing display modes and corresponding preferences. Processing displays window 750 when a user registers a new event and when a user configures a display mode (see FIGS. 5, 6, and corresponding text for further details regarding display mode viewing).

Window 750 includes column 760, column 765, column 770, and column 775. Column 760 includes a list of display mode descriptions corresponding to stored display modes. Row 780 shows the first display mode's corresponding description is “LL Square”. A user may enter a description using a media input device, such as a remote control. Column 765 includes a shape preference corresponding to each display mode. Row 780 shows the shape of the “LL Square” display mode is “square”. When selection a shape preference, processing may provide the user with options such as “square”, “circle”, or “rectangle”. Column 770 includes a list of positions as to where the pop-up window appears when the corresponding identified event occurs. Row 780 shows that the “LL Square” pop-up window will appear at the lower left corner of the screen. In one embodiment, processing may section a display into a three by five grid and provide the user with an option to select one of fifteen blocks as the pop-up overlay position setting. Column 775 includes a color preference corresponding to each display mode. If the color preference is “Yes”, then the corresponding identified event is shown in color. If the color preference is “No”, then the corresponding identified event is shown in black and white. Row 780 shows that the “LL Square” display mode is “Yes”.

FIG. 8 is a flowchart showing steps taken in receiving an event identifier and processing a corresponding identified event. Media manager processing commences at 800, whereupon processing retrieves information corresponding to one or more registered events from registered events data store 825. Registered event information includes an event description (i.e. “Sosa at Bat”), a detection identifier (i.e. “1234”), a channel locator (i.e. “53”), and a timeframe (i.e. 2:30 pm-5:00 pm). In one embodiment, registered event information includes an event description and a detection identifier but does not include a channel locater or a timeframe (see FIGS. 4, 5, and corresponding text for further information regarding event registration). Registered events data store 825 may be stored on a nonvolatile storage area, such as a computer hard drive.

Processing waits to receive an event identifier from provider 815 at step 810. An event identifier may be in the form of a unique value, such as “1234”, and informs processing that a particular event is occurring. The event identifier may have a “start” flag to inform processing when the event starts as well as an “end” flag to inform processing when the event completes. In one embodiment, processing may configure a tuner to receive event identifiers from a particular channel, such as “channel 53”.

Once processing receives an event identifier, a determination is made as to whether the event identifier matches one of the registered event's detection identifiers (decision 820). For example, if the event identifier is “1234”, processing determines whether a detection identifier has a value of “1234”. If the event identifier does not match one of the detection identifiers, decision 820 branches to “No” branch 822 which loops back to wait for the next event identifier. This looping continues until processing matches a received event identifier with one of the detection identifiers, at which point decision 820 branches to “Yes” branch 828.

Processing retrieves preference information settings corresponding to the registered event from preferences data store 835 (step 830). Preference information includes display mode preferences, an audio preference, and a deferred viewing preference. Display mode preferences identify how a pop-up window appears for displaying an identified event. The audio preference identifies whether audio corresponding to an identified event will be played. The deferred viewing preference identifies whether an identified event will be played immediately or stored in a nonvolatile storage area for later viewing (see FIGS. 5, 7 and corresponding text for further details regarding preference settings). Processing selects identified event 818 which corresponds to the matched event identifier, and formats identified event 818 using the preference information settings, resulting in a formatted identified event (step 840).

A determination is made as to whether the user wishes to defer viewing of the formatted identified event by checking the retrieved deferred viewing preference setting (decision 850). If the user chose to defer viewing of identified event 818, decision 850 branches to “Yes” branch 852 whereupon processing stores the formatted identified event in summary data store 860 (step 855). On the other hand, if the user chose to view the formatted identified event immediately, decision 850 branches to “No” branch 858 whereupon processing overlays or merges the formatted identified event with existing content which results in a composite media. During an overlay, or merging, process, existing content may be reformatted in order to display the formatted identified event. The existing content may be a television program that the user is currently viewing, such as a movie. Processing displays the composite media on media device 875 at step 870. For example, the composite media may include a movie with a small pop-up window that includes a baseball player at bat.

A determination is made as to whether the identified event is finished (decision 880). This determination may be made by monitoring a corresponding event identifier that includes an “end” flag indicating the event is finished. If the identified event is not finished, decision 880 branches to “No” branch 882 which loops back to continue displaying the composite media. This looping continues until the identified event is finished, at which point decision 880 branches to “Yes” branch 884.

Processing removes the composite media from display 875 and displays the existing content. Using the example described above, processing removes the pop-up window and displays the movie. Processing ends at 890.

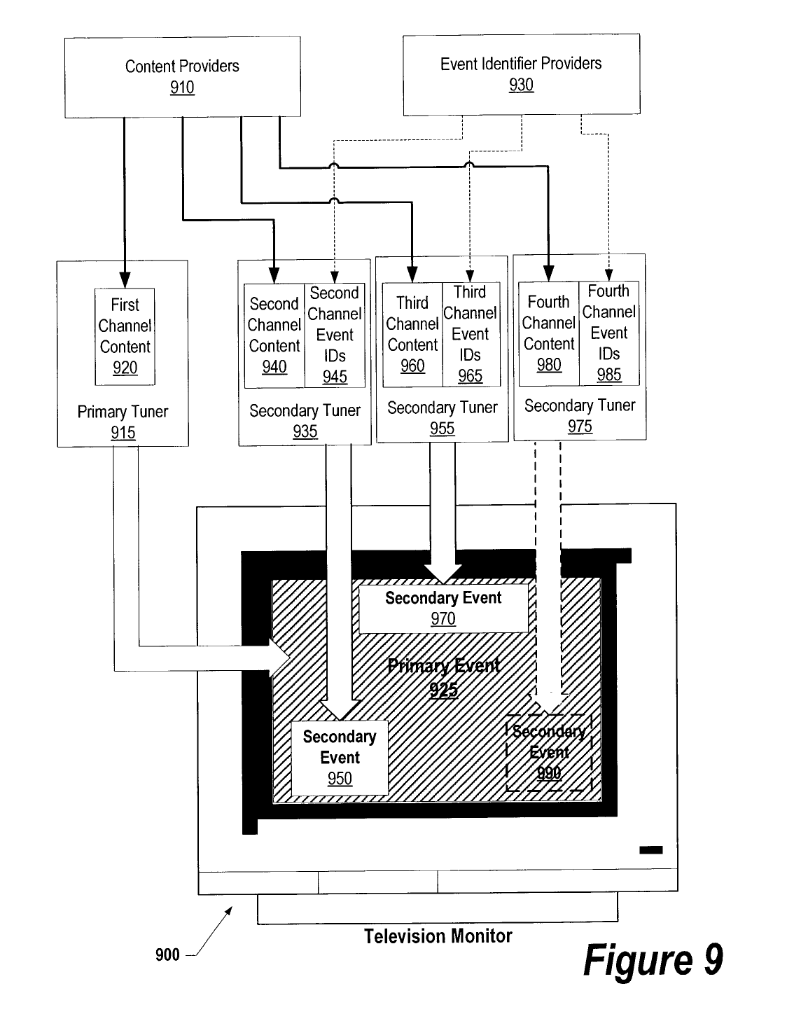

FIG. 9 is a diagram of one embodiment of the invention utilizing multiple tuners to detect desired event identifiers. Television monitor 900 includes multiple tuners for receiving content, or events, and displaying them on television monitor screen 905. The tuners shown in FIG. 9 include primary tuner 915, and secondary tuners 935, 955, and 975.

Content providers 910, such as cable television providers and satellite television providers, send a variety of content to the user through a variety of channels. First channel content 920 is the event, or content, that is currently being sent over the first channel. For example, first channel content 920 may be a movie being provided by Home Box Office (HBO). The user tunes the television monitor (or a cable set top box attached to the television monitor) to the channel corresponding to HBO whereupon the primary tuner displays the first channel content in primary event window 925 within the television monitor.

As described hereinbefore, the user can request that events that occur at non-predetermined times be displayed in separate windows that appear on screen 905. In the example shown, secondary tuners 935, 955, and 975 correspond to windows 950, 970, and 990, respectively. Two of the windows, 950 and 970, are shown as being “active” indicating that events have been identified and are currently being shown in the windows. On the other hand, third window 990 is shown as “inactive” (hidden) indicating that content matching the user's selection has not yet occurred for the tuner and channel that corresponds to third window 990.

For each of the secondary tuners on which the user wishes to display non-predetermined events, the user selects one or more event identifiers. The user registers with one or more event providers 930. The event identifier providers may include content providers 910 as well as third party event identifier providers, such as the content producer and third party websites (such as a fan club, sports organization, or the like).

Secondary tuners 935, 955, and 975 each receive content for the channel to which the tuner is directed (channel content 940, 960, and 980, respectively). Event identifiers are received that correspond to the channels (second channel event identifiers 945 correspond to second channel content 940, third channel event identifiers 965 correspond to third channel content 960, and fourth channel event identifiers 975 correspond to fourth channel content 980). For example, the user could select event identifiers 945 for secondary tuner 935 that corresponds to when a particular player is at bat in a baseball game currently playing on second channel 940 and configure the tuner to display the event, when it happens, in window 950. When the event is not being displayed, window 950 is hidden and the area is occupied by images displayed in primary event window 925.

Likewise, third tuner 955 could be tuned to a business channel 960 with event identifiers 965 selected to display the business channel in window 970 when a particular company is being analyzed. Again, when the company is not being analyzed on the business channel, window 970 is hidden and the area is occupied by images displayed in primary event window 925.

Fourth tuner 975 receives content 980 from another channel, such as a weather channel. Again, event identifiers 985 have been selected, perhaps to display the weather channel if a weather warning has been issued for the user's geographic location. In the example, the event identifiers have not been received and, consequently, window 990 within screen 905 is hidden. When a matching weather warning is issued, event identifier provider 930 sends the event identifier to the user's television monitor or set top box. When the tuner receives the identifier, tuner 975 displays the weather channel onto screen 905 in window 990.

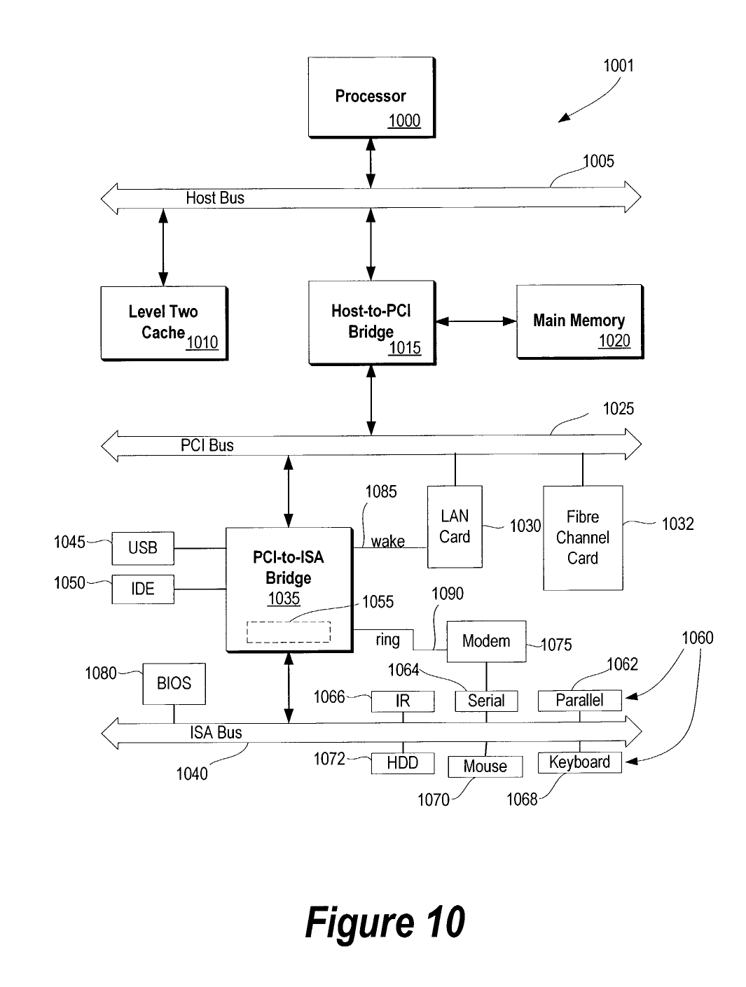

FIG. 10 illustrates information handling system 1001 which is a simplified example of a computer system capable of performing the invention described herein. Computer system 1001 includes processor 1000 which is coupled to host bus 1005. A level two (L2) cache memory 1010 is also coupled to the host bus 1005. Host-to-PCI bridge 1015 is coupled to main memory 1020, includes cache memory and main memory control functions, and provides bus control to handle transfers among PCI bus 1025, processor 1000, L2 cache 1010, main memory 1020, and host bus 1005. PCI bus 1025 provides an interface for a variety of devices including, for example, LAN card 1030. PCI-to-ISA bridge 1035 provides bus control to handle transfers between PCI bus 1025 and ISA bus 1040, universal serial bus (USB) functionality 1045, IDE device functionality 1050, power management functionality 1055, and can include other functional elements not shown, such as a real-time clock (RTC), DMA control, interrupt support, and system management bus support. Peripheral devices and input/output (I/O) devices can be attached to various interfaces 1060 (e.g., parallel interface 1062, serial interface 1064, infrared (IR) interface 1066, keyboard interface 1068, mouse interface 1070, and fixed disk (HDD) 1072) coupled to ISA bus 1040. Alternatively, many I/O devices can be accommodated by a super I/O controller (not shown) attached to ISA bus 1040. BIOS 1080 is coupled to ISA bus 1040, and incorporates the necessary processor executable code for a variety of low-level system functions and system boot functions. BIOS 1080 can be stored in any computer readable medium, including magnetic storage media, optical storage media, flash memory, random access memory, read only memory, and communications media conveying signals encoding the instructions (e.g., signals from a network). In order to attach computer system 1001 to another computer system to copy files over a network, LAN card 1030 is coupled to PCI bus 1025 and to PCI-to-ISA bridge 1035. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of handling media events that occur at non-predetermined times, said method comprising:
receiving a plurality of event identifiers from an external source, wherein each event identifier corresponds to an identified event;
retrieving one or more detection identifiers from a storage area, the detection identifiers corresponding to desired events; and
providing the identified events in response to matching the detection identifiers to the event identifiers.

2. The method as described in claim 1 further comprising:
receiving, at a first tuner, primary channel content from the external source;
displaying the primary channel content on a display screen;
monitoring a plurality of detection identifiers corresponding to a plurality of secondary channels, each of the secondary channels corresponding to a secondary tuner; and
displaying the identified events from the plurality of secondary channels on secondary windows within the display screen, wherein each of the secondary windows corresponds with one of the secondary tuners.

3. The method as described in claim 1 wherein the providing further comprises:
combining one of the identified events with existing content, the combining resulting in composite media; and
displaying the composite media.

4. The method as described in claim 1 further comprising:
formatting one of the identified events using one or more display mode preferences, wherein the formatting results in a formatted event; and
displaying the formatted event on a display device.

5. The method as described in claim 4 further comprising:
retrieving an audio preference corresponding to one of the matched detection identifiers;
determining whether to include an audio signal corresponding to the identified event in the formatted event based upon the audio preference; and
including the audio signal with the formatted event in response to the determination.

6. The method as described in claim 1 further comprising:
selecting a new desired event;
assigning a new detection identifier and one or more registered event preferences to the new desired event; and
storing the new detection identifier and the registered event preferences on a nonvolatile storage device.

7. The method as described in claim 1 further comprising:
registering an event at a website;
detecting one or more matched event identifiers from the website, wherein the website specified the matched event identifiers by matching event identifiers with the registered website event; and
performing the providing in response to the detecting.

8. An information handling system comprising:
one or more processors;
a memory accessible by the processors;
a display device accessible from one or more processors;
one or more nonvolatile storage devices accessible by the processors;
a network interface for receiving television media; and
an event handling tool to handle events that occur at non-predetermined times, the event handling tool including:
means for receiving a plurality of event identifiers from an external source through the network interface, wherein each event identifier corresponds to an identified event;
means for retrieving one or more detection identifiers from one of the nonvolatile storage devices, the detection identifiers corresponding to desired events; and
means for displaying the identified events in response to matching the detection identifiers to the event identifiers on the display device.

9. The information handling system as described in claim 8 further comprising:
means for combining one of the identified events with existing content, the combining resulting in composite media; and
means for displaying the composite media on the display device.

10. The information handling system as described in claim 8 further comprising:
a primary tuner and a plurality of secondary tuners accessible from the processors;
means for receiving, at the primary tuner, primary channel content from the external source through the network interface;
means for displaying the primary channel content on the display device;
means for monitoring a plurality of detection identifiers received through the network interface, the detection identifiers corresponding to a plurality of secondary channels, each of the secondary channels corresponding to one of the secondary tuners; and
means for displaying the identified events from the plurality of secondary channels on secondary windows on the display device's screen, wherein each of the secondary windows corresponds with one of the secondary tuners.

11. The information handling system as described in claim 8 further comprising:
means for formatting one of the identified events using one or more display mode preferences, wherein the formatting results in a formatted event; and
means for displaying the formatted event on the display device.

12. The information handling system as described in claim 11 further comprising:
means for retrieving an audio preference from one of the nonvolatile storage devices corresponding to one of the matched detection identifiers;
means for determining whether to include an audio signal corresponding to the identified event in the formatted event based upon the audio preference; and
means for including the audio signal with the formatted event in response to the determination.

13. The information handling system as described in claim 8 further comprising:
means for selecting a new desired event;
means for assigning a new detection identifier and one or more registered event preferences to the new desired event; and
means for storing the new detection identifier and the registered event preferences on one of the nonvolatile storage devices.

14. A computer program product stored in a computer operable media for handling events that occur at non-predetermined times, said computer program product comprising:
means for receiving a plurality of event identifiers from an external source, wherein each event identifier corresponds to an identified event;
means for retrieving one or more detection identifiers from a storage area, the detection identifiers corresponding to desired events; and
means for providing the identified events in response to matching the detection identifiers to the event identifiers.

15. The computer program product as described in claim 14 further comprising:
means for receiving, at a first tuner, primary channel content from the external source;
means for displaying the primary channel content on a display screen;
means for monitoring a plurality of detection identifiers corresponding to a plurality of secondary channels, each of the secondary channels corresponding to a secondary tuner; and
means for displaying the identified events from the plurality of secondary channels on secondary windows within the display screen, wherein each of the secondary windows corresponds with one of the secondary tuners.

16. The computer program product as described in claim 14 wherein the means for providing further comprises:
means for combining one of the identified events with existing content, the combining resulting in composite media; and
means for displaying the composite media.

17. The computer program product as described in claim 14 further comprising:
means for formatting one of the identified events using one or more display mode preferences, wherein the formatting results in a formatted event; and
means for displaying the formatted event on a display device.

18. The computer program product as described in claim 17 further comprising:
means for retrieving an audio preference corresponding to one of the matched detection identifiers;
means for determining whether to include an audio signal corresponding to the identified event in the formatted event based upon the audio preference; and
means for including the audio signal with the formatted event in response to the determination.

19. The computer program product as described in claim 14 further comprising:
means for selecting a new desired event;
means for assigning a new detection identifier and one or more registered event preferences to the new desired event; and
means for storing the new detection identifier and the registered event preferences on a nonvolatile storage device.

20. The computer program product as described in claim 14 further comprising:
means for registering an event at a website;
means for detecting one or more matched event identifiers from the website, wherein the website specified the matched event identifiers by matching event identifiers with the registered website event; and
means for performing the providing in response to the detecting.
